(19) United States
(12) Patent Application Publication
(10) Pub. No.: US 2025/0249451 A1
(43) Pub. Date: Aug. 7, 2025

(54) MICROCHAMBER ARRAY

(71) Applicant: Japan Display Inc., Tokyo (JP)

(72) Inventors: Junko NAGASAWA, Tokyo (JP); Yasushi TOMIOKA, Tokyo (JP)

(73) Assignee: Japan Display Inc., Tokyo (JP)

(21) Appl. No.: 19/044,706

(22) Filed: Feb. 4, 2025

(30) Foreign Application Priority Data
Feb. 7, 2024 (JP) 2024-016918

(51) Int. Cl. B01L 3/00

(52) U.S. Cl. CPC B01L 3/502715; B01L 2300/0819; B01L 2300/168

(57) ABSTRACT

According to an aspect, a microchamber array includes: a first substrate; a second substrate facing the first substrate; a flow channel provided between the first substrate and the second substrate, a solvent containing a sample flowing through the flow channel; a chamber body provided on a surface of the first substrate facing the second substrate; and a plurality of storage portions provided in the chamber body. The chamber body includes a first resin layer and a second resin layer, the second resin layer and the first resin layer are stacked in this order on the first substrate, autofluorescence generated when the second resin layer is irradiated with excitation light is smaller than autofluorescence generated when the first resin layer is irradiated with excitation light, and a contact angle of the first resin layer to water is larger than a contact angle of the second resin layer to water.

### CROSS-REFERENCE TO RELATED APPLICATION

This application claims the benefit of priority from Japanese Patent Application No. 2024-016918 filed on Feb. 7, 2024, the entire contents of which are incorporated herein by reference.

### BACKGROUND

### 1. Technical Field

The present disclosure relates to a microchamber array.

### 2. Description of the Related Art

Japanese Patent Application Laid-open Publication No. 2015-40754 (JP-A-2015-40754) and WO 2014/034781 disclose high-density microchamber arrays (“microchamber array” in WO 2014/034781) including flow channels through which a solvent containing a biological sample flows and a plurality of microchambers (“storage portions” in WO 2014/034781) that open into the flow channel.

The flow channels and the microchambers of the high-density microchamber arrays described in JP-A-2015-40754 and WO 2014/034781 are made of materials with conflicting properties, namely, hydrophobic material and hydrophilic material. For this reason, a hydrophobic solvent and a hydrophilic solvent may possibly fail to be satisfactorily separated in the microchambers depending on the types and properties of the solvents. When the microchamber array is irradiated with excitation light, light emitted from resin or other material used in the chamber body is detected due to the excitation light. To perform a fluorescent analysis on the sample, it is desired to suppress light emission from the resin or other material.

For the foregoing reasons, there is a need for providing a microchamber array that can satisfactorily separate a hydrophobic solvent and a hydrophilic solvent in storage portions to improve the sensitivity for detecting fluorescence.

### SUMMARY

According to an aspect, a microchamber array includes: a first substrate; a second substrate facing the first substrate; a flow channel provided between the first substrate and the second substrate, a solvent containing a sample flowing through the flow channel; a chamber body provided on a surface of the first substrate facing the second substrate; and a plurality of storage portions provided in the chamber body. The chamber body includes a first resin layer and a second resin layer, the second resin layer and the first resin layer are stacked in this order on the first substrate, autofluorescence generated when the second resin layer is irradiated with excitation light is smaller than autofluorescence generated when the first resin layer is irradiated with excitation light, and a contact angle of the first resin layer to water is larger than a contact angle of the second resin layer to water.

### BRIEF DESCRIPTION OF THE DRAWINGS

FIG. 1 is a plan view schematically illustrating a microchamber array according to a first embodiment;

FIG. 2 is a sectional view along line II-II′ of FIG. 1;

FIG. 3 is a view for explaining a state where solvents flow in a flow channel in the microchamber array according to the first embodiment;

FIG. 4 is a plan view schematically illustrating a configuration example of a plurality of storage portions of the microchamber array according to the first embodiment;

FIG. 5 is a sectional view along line V-V′ of FIG. 4;

FIG. 6 is a sectional view schematically illustrating a chamber body according to a first modification of the first embodiment;

FIG. 7 is a sectional view schematically illustrating the chamber body according to a first comparative example;

FIG. 8 is a sectional view schematically illustrating the chamber body according to a second comparative example;

FIG. 9 is a plan view schematically illustrating a configuration example of the storage portions of the microchamber array according to a second modification of the first embodiment;

FIG. 10 is a plan view schematically illustrating a configuration example of the storage portions of the microchamber array according to a third modification of the first embodiment;

FIG. 11 is a plan view schematically illustrating a configuration example of the storage portions of the microchamber array according to a fourth modification of the first embodiment;

FIG. 12 is a plan view schematically illustrating a configuration example of the storage portions of the microchamber array according to a fifth modification of the first embodiment;

FIG. 13 is a sectional view schematically illustrating the chamber body according to a sixth modification of the first embodiment;

FIG. 14 is a sectional view schematically illustrating the chamber body according to a seventh modification of the first embodiment;

FIG. 15 is a sectional view schematically illustrating the chamber body according to an eighth modification of the first embodiment; and

FIG. 16 is a sectional view schematically illustrating the chamber body according to a ninth modification of the first embodiment.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below can be appropriately combined. What is disclosed herein is given by way of example only, and appropriate changes made without departing from the spirit of the present disclosure and easily conceivable by those skilled in the art naturally fall within the scope of the disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present disclosure and the figures, components similar to those previously described with reference to previous figures are denoted by like reference numerals, and detailed explanation thereof may be appropriately omitted.

When the term “on” is used to describe an aspect where a first structure is disposed on a second structure in the present specification and the claims, it includes both of the following cases unless otherwise noted: a case where the first structure is disposed directly on and in contact with the second structure, and a case where the first structure is disposed on the second structure with another structure interposed therebetween.

### First Embodiment

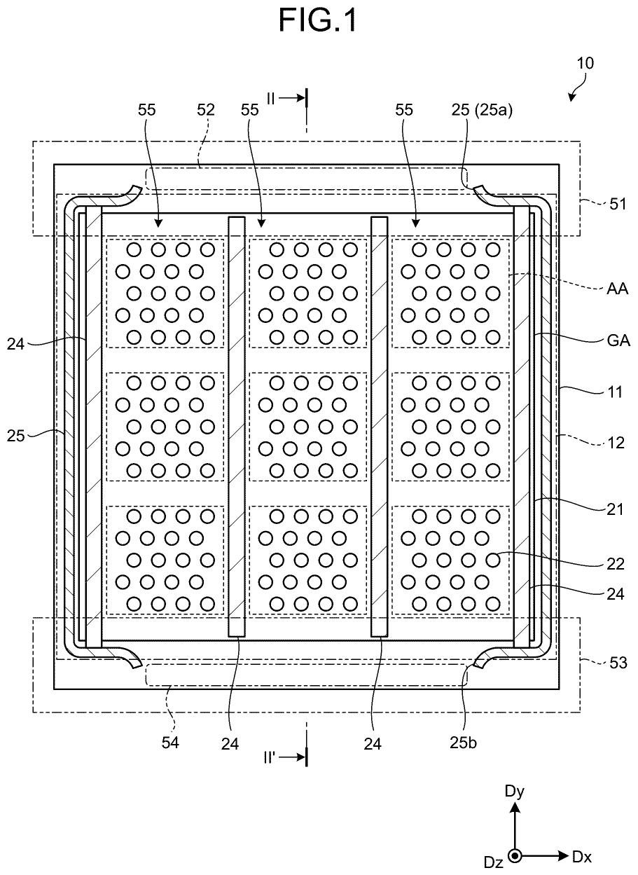

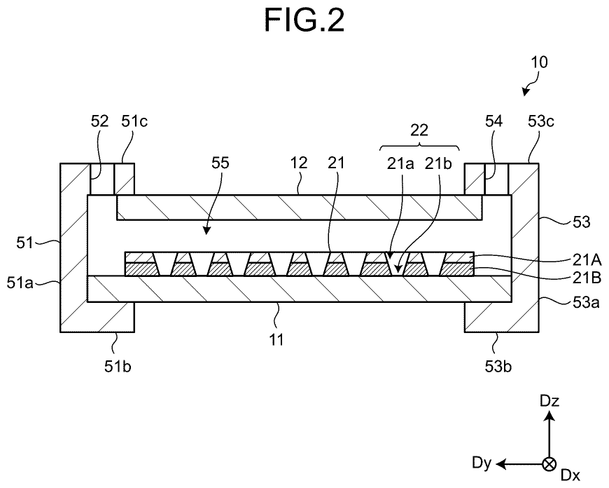

FIG. 1 is a plan view schematically illustrating a microchamber array according to a first embodiment. FIG. 2 is a sectional view along line II-II′ of FIG. 1. In FIG. 1, a second substrate 12, an injection jig 51, and a discharge jig 53 are represented by alternate long and two short dashes lines to make the drawing easier to see.

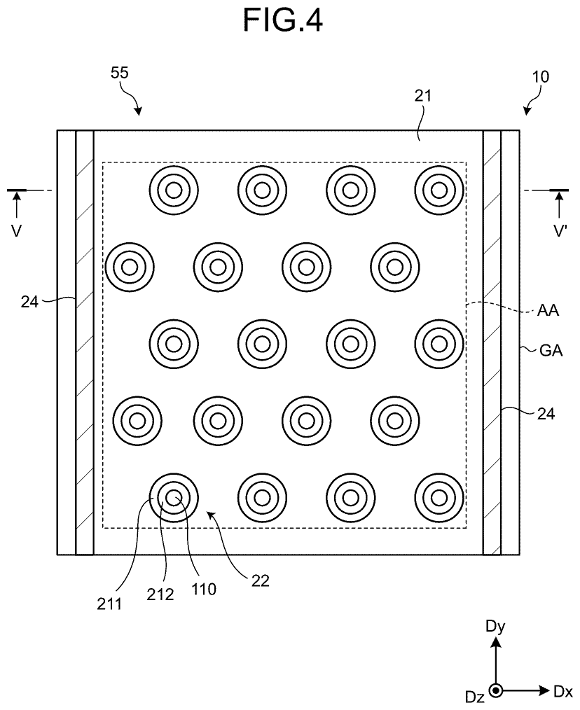

As illustrated in FIGS. 1 and 2, a microchamber array 10 includes a first substrate 11, the second substrate 12, a chamber body 21, a plurality of storage portions 22, a plurality of spacers 24, and a sealing part 25. While the storage portions 22 are not illustrated in FIGS. 1 to 3, the configuration of the storage portions 22 will be described later in greater detail with reference to FIG. 4.

The first substrate 11 is a flat plate-like member and is a glass substrate, for example. The second substrate 12 is disposed facing the first substrate 11 with a gap interposed therebetween. The second substrate 12 is a flat plate-like member and is a glass substrate, for example. The first substrate 11 and the second substrate 12 may be made of other materials, such as silicon and resin. To observe a sample accommodated in the storage portions 22, at least one of the first substrate 11 and the second substrate 12 is made of light-transmitting material.

As illustrated in FIG. 2, the chamber body 21 is provided on the surface of the first substrate 11, that is, the surface of the first substrate 11 facing the second substrate 12. The chamber body 21 includes a first resin layer 21A and a second resin layer 21B. In the chamber body 21, the second resin layer 21B and the first resin layer 21A are stacked in this order on the first substrate 11.

The first resin layer 21A is a hydrophobic film and is made of water-repellent resin. The first resin layer 21A, for example, has a structure with its surface processed with a polymer film, such as resin containing a fluorine-based or silicone-based component that controls surface energy, acrylic resin, epoxy resin, polyimide, polymer having a fluoroalkyl group on the side chain (e.g., a polymer of fluoroalkyl ethyl methacrylate and a copolymer of methacrylate), and polysiloxane (polymer having a hydrophobic methyl group or a highly hydrophobic fluoroalkyl group on the side chain of siloxane). More specifically, the first resin layer 21A has a poor wettability with aqueous solutions and is highly water repellent. The first resin layer 21A has an excellent affinity for oil.

The second resin layer 21B is made of resin containing black pigments, such as titanium or carbon, and having low light transmittance. Autofluorescence generated when the second resin layer 21B is irradiated with excitation light is smaller than that generated when the first resin layer 21A is irradiated with excitation light.

Therefore, the amount of autofluorescence generated when the upper surface of the chamber body 21 is irradiated with the excitation light is smaller than that generated when the lower surface of the chamber body 21 is irradiated with the excitation light.

The first resin layer 21A has higher water repellency than the second resin layer 21B. Therefore, the contact angle of the first resin layer 21A to water is larger than that of the second resin layer 21B to water.

With this configuration, the surface free energy of the surface of the first resin layer 21A and a bottom surface 110 of the storage portion 22 can be controlled, and a hydrophobic solvent and a hydrophilic solvent can be satisfactorily separated in the storage portion.

The chamber body 21 has a storage portion formation region AA and a peripheral region GA. The storage portion formation region AA is a region where the storage portions 22 are formed. In the example illustrated in FIG. 1, a plurality of storage portion formation regions AA are arranged in a matrix (row-column configuration) in the chamber body 21. The peripheral region GA is a region where the storage portions 22 are not formed. The peripheral region GA is provided between the storage portion formation regions AA and on the side closer to the outer periphery of the chamber body 21 than the storage portion formation regions AA.

In the following description, a first direction Dx is one direction in a plane parallel to the surface of the first substrate 11. A second direction Dy is one direction in the plane parallel to the surface of the first substrate 11 and is orthogonal to the first direction Dx. The second direction Dy may intersect the first direction Dx without being orthogonal thereto. A third direction Dz is a direction orthogonal to the first direction Dx and the second direction Dy. The third direction Dz is the direction normal to the surface of the first substrate 11. The term “plan view” refers to the positional relation when viewed from a direction perpendicular to the surface of the first substrate 11.

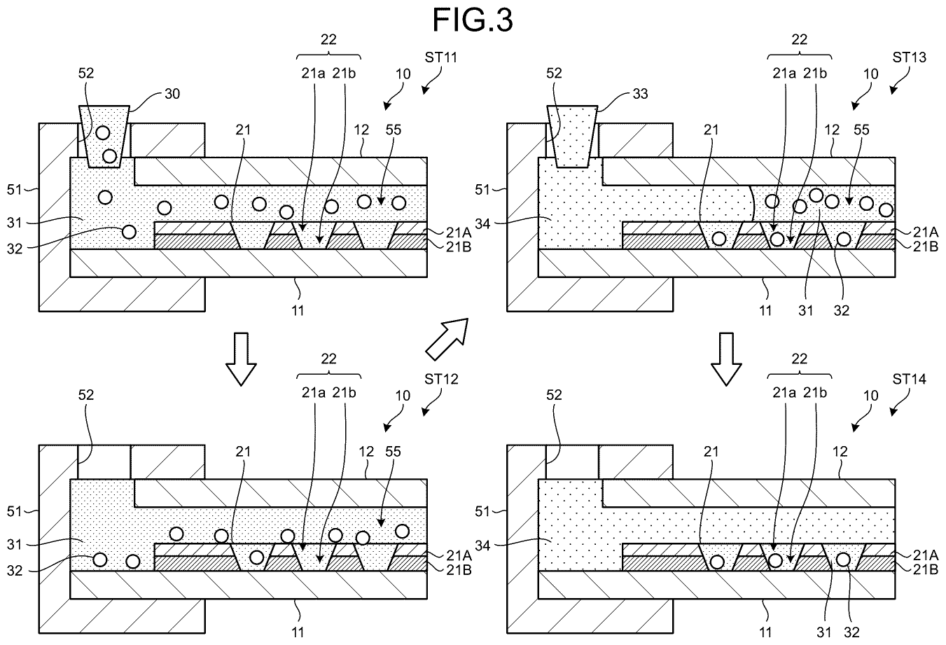

As illustrated in FIG. 2, the storage portions 22 are recesses formed in the chamber body 21. The storage portions 22 each have a first recess 21a formed in the first resin layer 21A and a second recess 21b formed in the second resin layer 21B. The storage portions 22 are spaces for accommodating a solvent 31 (refer to FIG. 3) containing a sample to be detected and are also called minute chambers or microchambers. The storage portions 22 are formed through the chamber body 21 in the thickness direction. In other words, the inner walls of the storage portions 22 are composed of the material of the chamber body 21, and the bottom surfaces 110 of the storage portions 22 are composed of the surface of the first substrate 11, that is, glass, for example. The glass is more hydrophilic than the chamber body 21. In other words, the bottom surfaces 110 of the storage portions 22 are more hydrophilic than the surface of the chamber body 21.

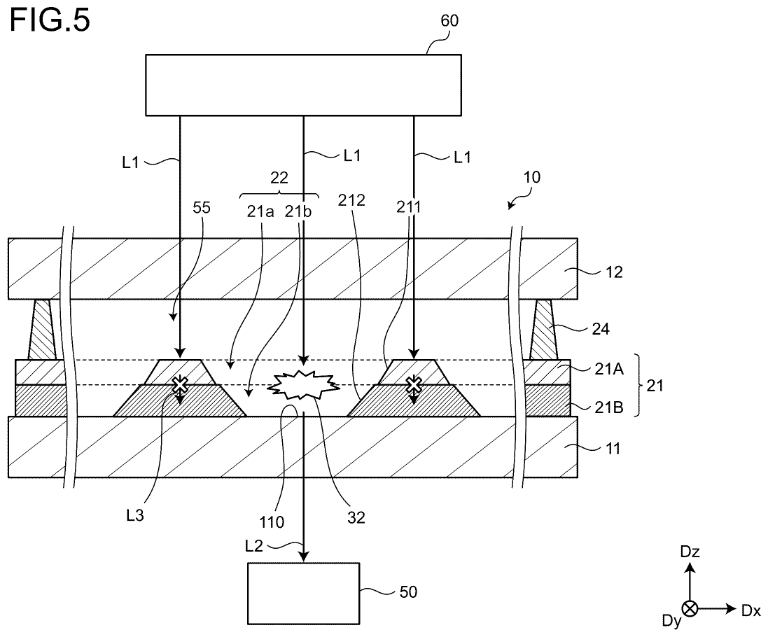

As illustrated in FIG. 1, the spacers 24 are wall-like members provided in the peripheral region GA of the chamber body 21. The spacers 24 are arrayed in the first direction Dx and each extend in the second direction Dy. A plurality of storage portion formation regions AA are arrayed in the second direction Dy between the spacers 24 adjacently disposed in the first direction Dx. The upper ends of the spacers 24 are in contact with the second substrate 12 (refer to FIG. 5). Thus, the distance between the chamber body 21 and the second substrate 12 in the third direction Dz is defined.

With this configuration, a flow channel 55 through which solvents 31 and 34 (refer to FIG. 3) flow from an inlet 52 to an outlet 54 is formed between the first substrate 11 and the second substrate 12 and between the spacers 24 in plan view. In the example illustrated in FIG. 1, there are three flow channels 55 separated by the spacers 24, and the three flow channels 55 each extend along the second direction Dy. The inlet 52 into which the solvent 31 is injected is formed on one side of the flow channel 55 in the second direction Dy, and the outlet 54 from which the solvent 31 is discharged is formed on the other side of the flow channel 55 in the second direction Dy.

The sealing part 25 is a member that bonds the first substrate 11 and the second substrate 12 and is provided to the part of the first substrate 11 closer to the outer periphery than the chamber body 21. The sealing part 25 is provided along the sides of the first substrate 11 extending in the second direction Dy. The sealing part 25 has a first opening 25a on the side corresponding to the inlet 52 and a second opening 25b on the side corresponding to the outlet 54 on the opposite side of the first opening 25a.

As illustrated in FIG. 2, the injection jig 51 is provided to cover one end of the first substrate 11 and the second substrate 12 in the second direction Dy. The discharge jig 53 is provided on the opposite side of the injection jig 51 to cover the other end of the first substrate 11 and the second substrate 12 in the second direction Dy. The injection jig 51 and the discharge jig 53 have first portions 51a and 53a, second portions 51b and 53b, and third portions 51c and 53c, respectively. The first portions 51a and 53a extend in the third direction Dz and are provided to cover the gap between the first substrate 11 and the second substrate 12. The second portions 51b and 53b are provided overlapping part of the back surface of the first substrate 11. The third portions 51c and 53c are provided overlapping part of the surface of the second substrate 12.

The third portion 51c of the injection jig 51 has the inlet 52 passing therethrough in the third direction Dz. The third portion 53c of the discharge jig 53 has the outlet 54 passing therethrough in the third direction Dz. The length of the second substrate 12 in the second direction Dy is shorter than that of the first substrate 11 in the second direction Dy. The inlet 52 of the injection jig 51 and the outlet 54 of the discharge jig 53 are each formed in a region not overlapping the second substrate 12. With this configuration, the inlet 52, the flow channel 55, and the outlet 54 communicate with each other.

FIG. 3 is a view for explaining a state where the solvents flow in the flow channel in the microchamber array according to the first embodiment. Each figure in FIG. 3 is an enlarged sectional view of a part of the microchamber array 10 near the inlet 52.

As illustrated in FIG. 3, a solvent supplier 30 (nozzle) is inserted into the inlet 52, and the solvent 31 is injected from the inlet 52 into the flow channel 55 (Step ST11). The solvent 31 is a hydrophilic solvent containing a sample to be detected (not illustrated) and reagents 32. Examples of the hydrophilic solvent include, but are not limited to, water, hydrophilic alcohol (specifically, those with a small hydrocarbon number, such as methanol, ethanol, and IPA), hydrophilic ether, ketone, nitrile solvent, dimethyl sulfoxide, N, N-dimethylformamide ionic solution, N, N-dimethylformamide electrolyte solution, etc. The sample to be detected is, for example, a biomolecule or a virus. The reagents 32 are materials that react with the sample.

Subsequently, the solvent supplier 30 is removed, and the microchamber array 10 is left for a certain period of time (Step ST12). The reagents 32 settle in the solvent 31 and are placed on/above the chamber body 21. Some of the reagents 32 are accommodated in the storage portions 22 together with the solvent 31 containing the sample to be detected.

Subsequently, a solvent supplier 33 (nozzle) is inserted into the inlet 52, and the solvent 34 is injected from the inlet 52 into the flow channel 55 (Step ST13). The solvent 34 is a hydrophobic solvent. Examples of the hydrophobic solvent include, but are not limited to, straight-chain saturated hydrocarbon such as n-hexadecane, cyclic saturated hydrocarbon such as cyclohexane, unsaturated hydrocarbon, aromatic hydrocarbon, silicone oil, perfluorocarbon, halogen-based solvent, etc. The solvent 34 is injected to push the solvent 31 and the reagents 32 injected at Steps ST11 and ST12 toward the outlet 54. As a result, the reagents 32 are accommodated in the storage portions 22.

Subsequently, the solvent 34 is filled into the flow channel 55 to cover the storage portions 22, and the solvent supplier 33 is removed (Step ST14). The storage portions 22 each accommodate the solvent 31 containing the sample to be detected and the reagents 32. The solvent 31 containing the sample to be detected and the reagents 32 accommodated in the storage portions 22 is covered with the solvent 34.

As described above, at least the bottom surfaces 110 of the storage portions 22 are hydrophilic, and the first resin layer 21A of the chamber body 21 is hydrophobic. In other words, the bottom surfaces 110 of the storage portions 22 have a high affinity for the solvent 31 containing the sample to be detected and the reagents 32, and the surface of the first resin layer 21A of the chamber body 21 has a high affinity for the solvent 34 that covers the storage portions 22.

Therefore, the solvent 31 containing the sample to be detected and the reagents 32 is efficiently accommodated in each of the storage portions 22 at Step ST14. The microchamber array 10 can detect whether the sample is present in each of the storage portions 22 by observing fluorescence from the sample sealed in each of the storage portions 22 from the back surface side of the first substrate 11.

The following describes the configuration of the storage portions 22 formed in the storage portion formation region AA in greater detail. FIG. 4 is a plan view schematically illustrating a configuration example of the storage portions of the microchamber array according to first embodiment. FIG. 5 is a sectional view along line V-V′ of FIG. 4.

As illustrated in FIG. 4, the storage portions 22 each have a side surface 211 of the first recess 21a, a side surface 212 of the second recess 21b, and the bottom surface 110. The storage portions 22 each have a circular shape in plan view and are arranged in a triangular lattice in the storage portion formation region AA. In other words, the storage portions 22 are arranged such that the positions of the storage portions 22 in the n-th column arrayed in the second direction Dy are shifted from the positions of the storage portions 22 in the n+1-column arrayed in the second direction Dy.

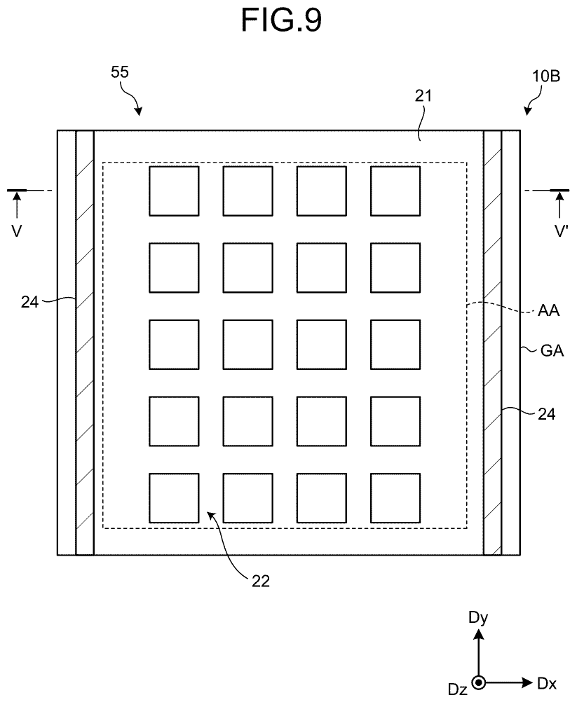

The arrangement, the number, and the like of the storage portions 22 illustrated in FIG. 4 are given by way of example only and can be changed as appropriate. Examples of different arrangements of the storage portions 22 will be described later with reference to FIGS. 9, 10, 11, and 12.

As illustrated in FIG. 5, the microchamber array 10 includes a light source 60 that outputs excitation light L1 and a detection circuit 50.

The detection circuit 50 is a charge coupled device and serves as an imaging circuit. The detection circuit 50 can detect the intensity of fluorescence and the emission intensity distribution of fluorescence.

The light source 60 outputs the excitation light L1 to the upper surface of the chamber body 21. The detection circuit 50 detects fluorescence L2 emitted by the sample in the storage portion 22 due to the excitation light L1. At this time, the first resin layer 21A emits autofluorescence L3 due to the excitation light L1. The second resin layer 21B can reduce the autofluorescence L3 emitted by the first resin layer 21A. As a result, the autofluorescence L3 emitted by the first resin layer 21A is less likely to be detected by the detection circuit 50. This configuration improves the detection accuracy of the detection circuit 50 detecting the fluorescence L2 emitted by the sample in the storage portion 22 due to the excitation light L1.

As illustrated in FIG. 5, the inner diameter of the first recess 21a is larger than that of the second recess 21b. The inner diameter of the second recess 21b corresponds to the diameter of the bottom surface of the second recess 21b, that is, the bottom surface 110 of the storage portion 22. The inner diameter of the first recess 21a corresponds to the diameter of the plane where the first recess 21a and the second recess 21b are in contact.

The side surface 211 of the first recess 21a and the side surface 212 of the second recess 21b are forward tapered.

With this configuration, the autofluorescence L3 emitted by the first resin layer 21A is reduced by the second resin layer 21B and is less likely to be detected by the detection circuit 50. Therefore, this configuration can increase the SNR of detecting the fluorescence of the sample and improve the detection accuracy.

The angle between the bottom surface 110 of the storage portion 22 and the side surface 211 of the first recess 21a is larger than that between the bottom surface 110 of the storage portion 22 and the side surface 212 of the second recess 21b. A step may be formed between the side surface 211 and the side surface 212.

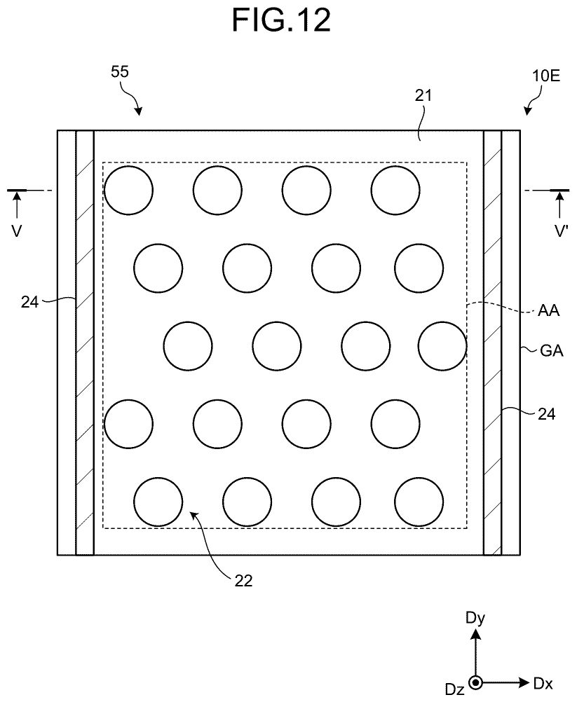

The inclinations of the side surface 211 of the first recess 21a and the side surface 212 of the second recess 21b with respect to the bottom surface 110 of the storage portion 22 illustrated in FIGS. 4 and 5 are given by way of example only and can be changed as appropriate. Examples of different inclinations of the side surface 211 of the first recess 21a and the side surface 212 of the second recess 21b with respect to the bottom surface 110 of the storage portion 22 will be described later with reference to FIGS. 13, 14, 15, and 16.

The thickness of the second resin layer 21B is thicker than that of the first resin layer 21A. This configuration can sufficiently make the autofluorescence L3 emitted by the first resin layer 21A less likely to be detected by the detection circuit 50.

The contact angle between the bottom surface 110 of the storage portion 22 and water is larger than 0° and equal to or smaller than 40°. The contact angle between the surface of the second resin layer 21B and water is larger than 40° and equal to or smaller than 70°. The contact angle between the surface of the first resin layer 21A and water is equal to or larger than 80° and smaller than 100°, and larger than 100° and equal to or smaller than 110°. The minimum contact angle between the surface of the first resin layer 21A and water is preferably 90°.

Therefore, the surface of the first resin layer 21A is more hydrophobic and has a higher affinity for oil, and the bottom surface 110 of the storage portion 22 is more hydrophilic and has a higher affinity for aqueous solutions.

The injection jig 51 and the discharge jig 53 may be provided integrally with the first substrate 11 and the second substrate 12 by a fixing member, which is not illustrated. Alternatively, the injection jig 51 and the discharge jig 53 may be provided removably from the first substrate 11 and the second substrate 12 as needed.

In the first embodiment, the fluorescence L2 of the sample is detected by irradiating the chamber body 21 with the excitation light L1. Alternatively, a reflective detection method may be employed in which the fluorescence L2 of the sample is detected by irradiating the lower surface of the chamber body 21 with the excitation light L1. As described above, the autofluorescence generated when the second resin layer 21B is irradiated with the excitation light L1 is smaller than the autofluorescence L3 generated when the first resin layer 21A is irradiated with the excitation light L1. Therefore, the amount of autofluorescence L3 generated when the upper surface of the chamber body 21 is irradiated with the excitation light is smaller than the amount of autofluorescence L3 generated when the lower surface of the chamber body 21 is irradiated with the excitation light. Thus, the autofluorescence L3 in the first resin layer 21A is less likely to be detected by the detection circuit 50 also in the reflective detection method.

### First Modification of the First Embodiment

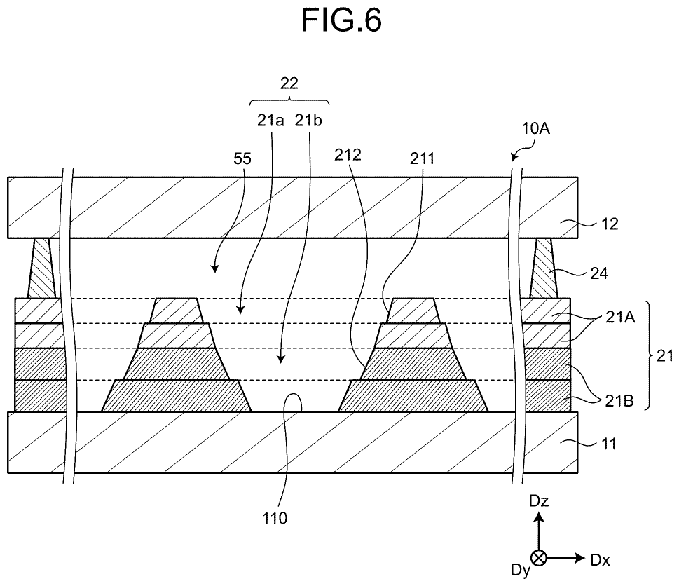

FIG. 6 is a sectional view schematically illustrating the chamber body according to a first modification of the first embodiment. In the following description, the same components as those described in the embodiment above are denoted by like reference numerals, and duplicated explanation is omitted.

As illustrated in FIG. 6, in the microchamber array 10A according to the first modification of the first embodiment, the first resin layer 21A and the second resin layer 21B are each composed of two layers and are thicker than those of the chamber body 21 according to the first embodiment. A step may be formed between the side surfaces 211 of the first recess 21a, and a step may be formed between the side surfaces 212 of the first recess 21b. The first resin layer 21A and the second resin layer 21B are not necessarily composed of two layers and may be composed of three or more layers. The bottom layer of the second resin layer 21B may be made of resin that does not emit light.

With this configuration, the aspect ratio of the storage portion 22 can be made larger than in the microchamber array 10 according to the first embodiment, thereby facilitating trapping the solvent 31 in the storage portion 22. Another second resin layer 21B may be interposed between the two layers of the first resin layer 21A.

### First Comparative Example of the First Embodiment

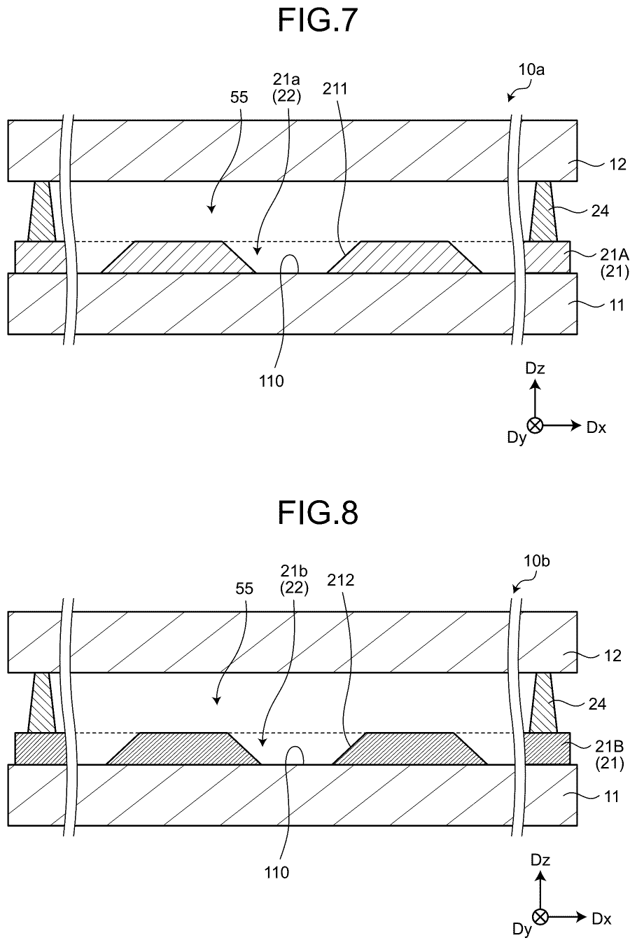

FIG. 7 is a sectional view schematically illustrating a configuration example of the storage portions of the microchamber array according to a first comparative example.

As illustrated in FIG. 7, in a microchamber array 10a according to the first comparative example, the chamber body 21 includes the first resin layer 21A but does not include the second resin layer 21B. In this configuration, the accuracy of detecting the fluorescence of the sample in the storage portion 22 is deteriorated by the autofluorescence of the first resin layer 21A. As a result, it is difficult to determine whether the fluorescence of the sample is present in the storage portion 22.

By contrast, in the chamber body 21 of the microchamber array 10 according to the first embodiment, the second resin layer 21B and the first resin layer 21A are stacked in this order on the substrate. With this configuration, the autofluorescence L3 emitted by the first resin layer 21A can be suppressed by the second resin layer 21B.

### Second Comparative Example of the First Embodiment

FIG. 8 is a sectional view schematically illustrating a configuration example of the storage portions of the microchamber array according to a second comparative example.

As illustrated in FIG. 8, in a microchamber array 10b according to the second comparative example, the chamber body 21 includes the second resin layer 21B but does not include the first resin layer 21A. In this configuration, the water repellency of the second resin layer 21B is insufficient, and the solvent 34 adheres to the surface of the second resin layer 21B. As a result, the solvent 31 and the solvent 34 are insufficiently separated in the storage portion 22, making it difficult to determine whether the fluorescence of the sample is present in the storage portion 22.

By contrast, in the chamber body 21 of the microchamber array 10 according to the first embodiment, the second resin layer 21B and the first resin layer 21A are stacked in this order on the substrate. This configuration increases the water repellency of the chamber body 21 and sufficiently separates the solvent 31 and the solvent 34.

### Second Modification of the First Embodiment

The following describes the examples of different arrangements of the storage portions 22 according to second to fifth modifications of the first embodiment. FIG. 9 is a plan view schematically illustrating a configuration example of the storage portions of the microchamber array according to the second modification of the first embodiment. In the following description, the same components as those described in the embodiment above are denoted by like reference numerals, and duplicated explanation is omitted.

As illustrated in FIG. 9, in a microchamber array 10B according to the second modification of the first embodiment, the storage portions 22 are each have a square shape in plan view and are arranged in a square lattice in the storage portion formation region AA.

Explanation of the configuration and action of the microchamber array 10B according to the second modification of the first embodiment is omitted because they are substantially the same as those of the first embodiment.

### Third Modification of the First Embodiment

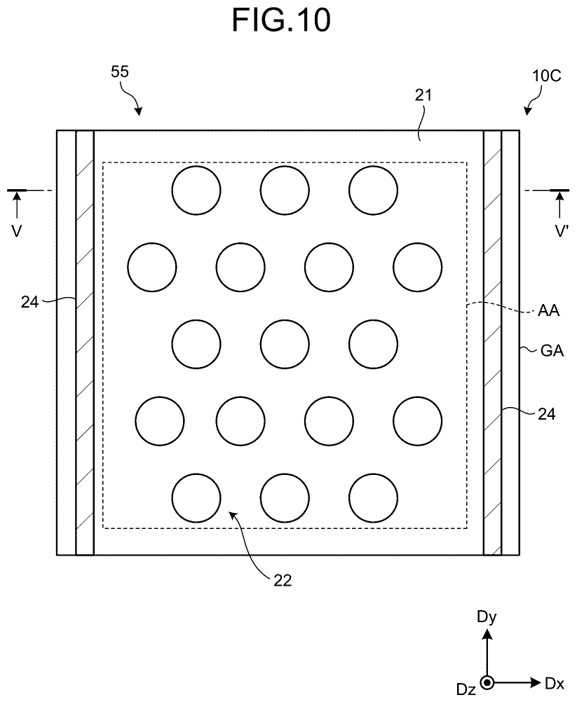

FIG. 10 is a plan view schematically illustrating a configuration example of the storage portions of the microchamber array according to the third modification of the first embodiment. In the following description, the same components as those described in the embodiment above are denoted by like reference numerals, and duplicated explanation is omitted.

As illustrated in FIG. 10, in a microchamber array 10C according to the third modification of the first embodiment, the storage portions 22 are each have a circular shape in plan view and are arranged in a rhombic lattice in the storage portion formation region AA.

Explanation of the configuration and action of the microchamber array 10C according to the third modification of the first embodiment is omitted because they are substantially the same as those of the first embodiment.

### Fourth Modification of the First Embodiment

FIG. 11 is a plan view schematically illustrating a configuration example of the storage portions of the microchamber array according to the fourth modification of the first embodiment. In the following description, the same components as those described in the embodiment above are denoted by like reference numerals, and duplicated explanation is omitted.

As illustrated in FIG. 11, in a microchamber array 10D according to the fourth modification of the first embodiment, the storage portions 22 are each have a circular shape in plan view and are arranged in a rectangular lattice in the storage portion formation region AA.

Explanation of the configuration and action of the microchamber array 10D according to the fourth modification of the first embodiment is omitted because they are substantially the same as those of the first embodiment.

### Fifth Modification of the First Embodiment

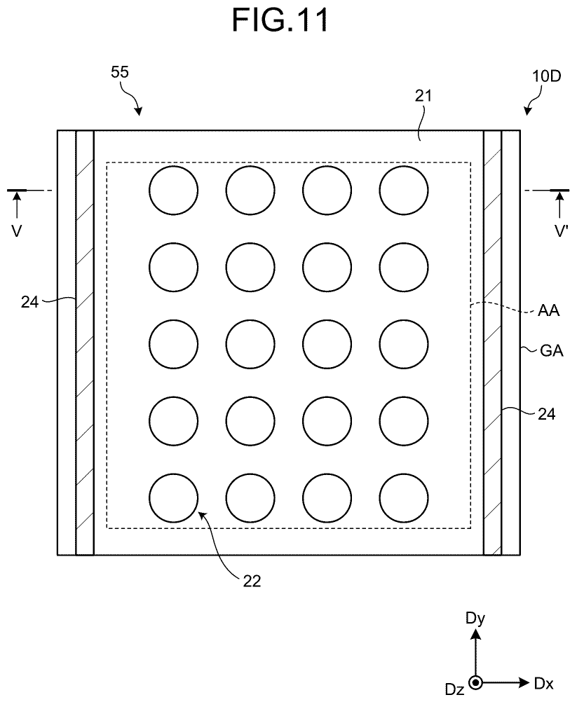

FIG. 12 is a plan view schematically illustrating a configuration example of the storage portions of the microchamber array according to the fifth modification of the first embodiment. In the following description, the same components as those described in the embodiment above are denoted by like reference numerals, and duplicated explanation is omitted.

As illustrated in FIG. 12, in a microchamber array 10E according to the fifth modification of the first embodiment, the storage portions 22 are each have a circular shape in plan view and are arranged in an oblique lattice in the storage portion formation region AA.

Explanation of the configuration and action of the microchamber array 10E according to the fifth modification of the first embodiment is omitted because they are substantially the same as those of the first embodiment.

### Sixth Modification of the First Embodiment

The following describes the examples of different inclinations of the side surface 211 of the first recess 21a and the side surface 212 of the second recess 21b with respect to the bottom surface 110 of the storage portion 22 according to sixth to ninth modifications of the first embodiment. FIG. 13 is a sectional view schematically illustrating the microchamber array according to the sixth modification of the first embodiment. In the following description, the same components as those described in the embodiment above are denoted by like reference numerals, and duplicated explanation is omitted.

As illustrated in FIG. 13, in a microchamber array 10F according to the sixth modification of the first embodiment, the angle between the bottom surface 110 of the storage portion 22 and the side surface 211 of the first recess 21a is larger than that between the bottom surface 110 of the storage portion 22 and the side surface 212 of the second recess 21b as in the microchamber array 10 according to the first embodiment. The resin of the first resin layer 21A covers part of the side surface 212.

Explanation of the configuration and action of the microchamber array 10F according to the sixth modification of the first embodiment is omitted because they are substantially the same as those of the first embodiment.

### Seventh Modification of the First Embodiment

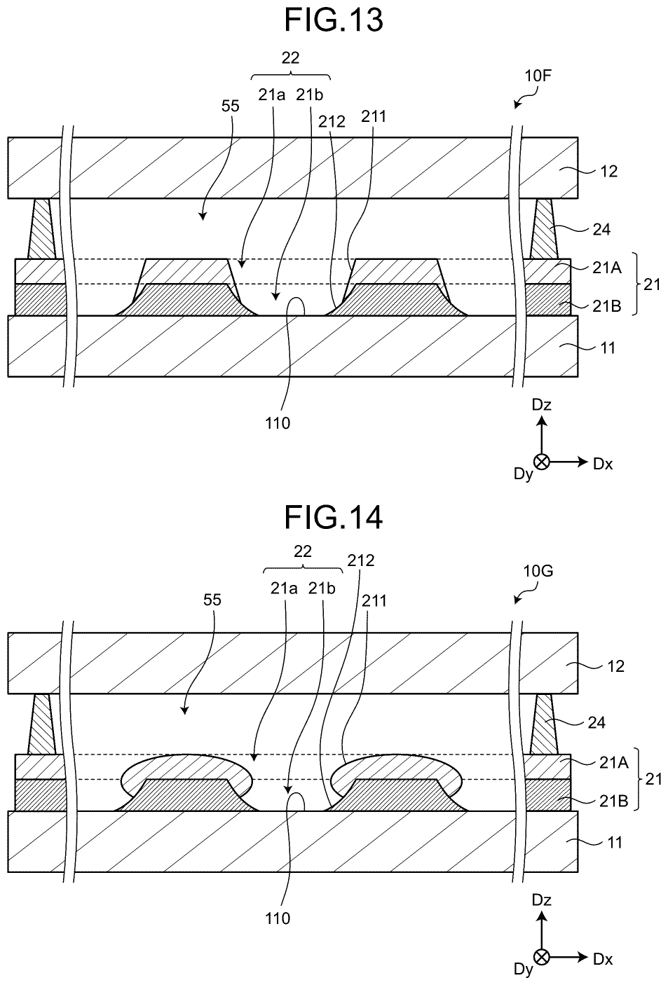

The following describes the magnitude relation between the inclination angles in the first recess and the second recess according to the seventh modification of the first embodiment. FIG. 14 is a sectional view schematically illustrating the microchamber array according to the seventh modification of the first embodiment. In the following description, the same components as those described in the embodiment above are denoted by like reference numerals, and duplicated explanation is omitted.

As illustrated in FIG. 14, in a microchamber array 10G according to the seventh modification of the first embodiment, the angle between the bottom surface 110 of the storage portion 22 and the side surface 211 of the first recess 21a is larger than that between the bottom surface 110 of the storage portion 22 and the side surface 212 of the second recess 21b as in the microchamber array 10 according to the first embodiment. The side surface 211 is rounded into an arc shape, and the resin of the first resin layer 21A covers part of the side surface 212.

Explanation of the configuration and action of the microchamber array 10G according to the seventh modification of the first embodiment is omitted because they are substantially the same as those of the first embodiment.

### Eighth Modification of the First Embodiment

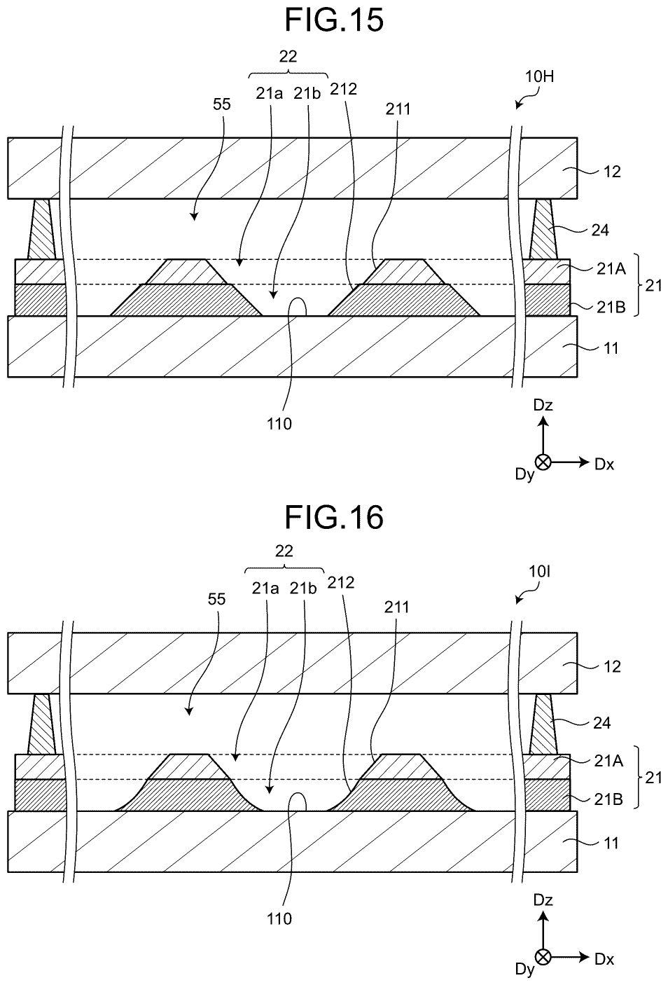

The following describes the magnitude relation between the inclination angles in the first recess and the second recess according to the eighth modification of the first embodiment. FIG. 15 is a sectional view schematically illustrating the microchamber array according to the eighth modification of the first embodiment. In the following description, the same components as those described in the embodiment above are denoted by like reference numerals, and duplicated explanation is omitted.

As illustrated in FIG. 15, in a microchamber array 10G according to the eighth modification of the first embodiment, the angle between the bottom surface 110 of the storage portion 22 and the side surface 211 of the first recess 21a is substantially equal to that between the bottom surface 110 of the storage portion 22 and the side surface 212 of the second recess 21b.

Explanation of the configuration and action of the microchamber array 10H according to the eighth modification of the first embodiment is omitted because they are substantially the same as those of the first embodiment.

### Ninth Modification of the First Embodiment

The following describes the magnitude relation between the inclination angles in the first recess and the second recess according to the ninth modification of the first embodiment. FIG. 16 is a sectional view schematically illustrating the microchamber array according to the ninth modification of the first embodiment. In the following description, the same components as those described in the embodiment above are denoted by like reference numerals, and duplicated explanation is omitted.

As illustrated in FIG. 16, in a microchamber array 10I according to the ninth modification of the first embodiment, the angle between the bottom surface 110 of the storage portion 22 and the side surface 211 of the first recess 21a is smaller than that between the bottom surface 110 of the storage portion 22 and the side surface 212 of the second recess 21b.

Explanation of the configuration and action of the microchamber array 10I according to the ninth modification of the first embodiment is omitted because they are substantially the same as those of the first embodiment.

While exemplary embodiments according to the present disclosure have been described, the embodiments are not intended to limit the disclosure. The contents disclosed in the embodiments are given by way of example only, and various modifications can be made without departing from the spirit of the present disclosure. Appropriate modifications made without departing from the spirit of the present disclosure naturally fall within the technical scope of the disclosure. At least one of various omissions, substitutions, and modifications of the components can be made without departing from the gist of the embodiments and modifications described above.

What is claimed is:

1. A microchamber array comprising:
a first substrate;
a second substrate facing the first substrate;
a flow channel provided between the first substrate and the second substrate, a solvent containing a sample flowing through the flow channel;
a chamber body provided on a surface of the first substrate facing the second substrate; and
a plurality of storage portions provided in the chamber body, wherein
the chamber body includes a first resin layer and a second resin layer,
the second resin layer and the first resin layer are stacked in this order on the first substrate,
autofluorescence generated when the second resin layer is irradiated with excitation light is smaller than autofluorescence generated when the first resin layer is irradiated with excitation light, and
a contact angle of the first resin layer to water is larger than a contact angle of the second resin layer to water.

2. The microchamber array according to claim 1, wherein
the first resin layer contains a fluorine-based or silicone-based component, and
the second resin layer contains titanium or carbon.

3. The microchamber array according to claim 2, wherein
the storage portions each have a first recess provided in the first resin layer and a second recess provided in the second resin layer, and
an inner diameter of the first recess is larger than an inner diameter of the second recess.

4. The microchamber array according to claim 3, wherein side surfaces of the first recess and the second recess are forward tapered.

5. The microchamber array according to claim 4, wherein a contact angle of water to a bottom surface of the storage portion is larger than 0° and equal to or smaller than 40°.

6. The microchamber array according to claim 5, wherein a contact angle of water to an upper surface of the first resin layer is equal to or larger than 80° and smaller than 100°, and larger than 100° and equal to or smaller than 110°.

7. The microchamber array according to claim 6, wherein the plurality of storage portions are arranged in one lattice of a triangular lattice, a square lattice, a rhombic lattice, a rectangular lattice, and an oblique lattice in plan view.
